(19) United States
(12) Patent Application Publication
(10) Pub. No.: US 2023/0014075 A1
(43) Pub. Date: Jan. 19, 2023

(54) ROUTE DISCOVERY IN ZIGBEE NETWORKS WITH COMBO NODES

(71) Applicant: SIGNIFY HOLDING B.V., EINDHOVEN (NL)

(72) Inventors: Robin MICHIELSEN, EINDHOVEN (NL); Bas DRIESEN, WEERT (NL); Bozena ERDMANN, AACHEN (DE)

(21) Appl. No.: 17/784,903

(22) PCT Filed: Dec. 8, 2020
(86) PCT No.: PCT/EP2020/085000

§ 371 Date: Jun. 13, 2022

(30) Foreign Application Priority Data
Dec. 17, 2019 (EP) 19217131.2

(51) Int. Cl. H04W 40/24; H05B 47/19

(52) U.S. Cl. CPC H04W 40/24; H05B 47/19; H04W 84/18

(57) ABSTRACT

The invention relates to the field of Zigbee wireless mesh communication networks and in particular to methods, systems and nodes (A,B,C,D) for use is such systems for establishing routes in mesh networks, wherein Zigbee router nodes (A,B,C) comprise a controller and radio transceiver and are arranged to include addresses of Zigbee End Device, ZED, child nodes (D) of the Zigbee router (C), in many-to-one route requests that the Zigbee router (C) transmits and/or include the addresses of the ZED child nodes (D) of the Zigbee router (C) in AODV route replies that the Zigbee router (C) transmits.

### FIELD OF THE INVENTION

The invention relates to the field of wireless communication networks and in particular to methods, systems and nodes for use is such systems for establishing routes in mesh networks.

### BACKGROUND OF THE INVENTION

There is an ongoing trend in the professional lighting market to move more and more towards connected lighting systems, which enable all kinds of new features like (remote) scheduling, energy monitoring, sensor-based lighting control and asset management. In many cases these systems are installed in existing buildings, in which cases a wireless network is preferred to avoid having to deploy new cables (for lighting control) through the ceiling. Examples of such wireless network protocols which are used widely in current practice are open standards like Zigbee, Thread, BLE, BLE mesh, Wi-Fi, Wi-Fi direct, and various proprietary network implementations built on top of the IEEE 802.15.4, IEEE 802.15.1 or IEEE 802.11 standards.

Zigbee networks, in particular lighting control networks can be very large.

### SUMMARY OF THE INVENTION

At the heart of the present invention is the insight from the inventors, that such large Zigbee networks are not only large but also generally very dense, in such dense networks having every node configured as a Zigbee router does not scale well; in fact it adds a lot of overhead even though many of the nodes will be within radio range from each other. As a result, the neighbour table (typically 16 or 26 entries) in each node will quickly fill up due to the close proximity of many other nodes. Notably any node that is not in the neighbour table requires a route over multiple hops (even though it may be within radio distance), thus adding overhead.

On top of this route discovery takes time and it is a burst of broadcast traffic that can temporarily negatively impact network performance. The overhead of having many router nodes in the network is also introduced by the Link Status messages that each router sends out periodically and due to the re-broadcasts of broadcasted Zigbee messages.

An existing solution to overcome the last issue (too many Link Status messages and re-broadcasts) is to assign some of the nodes the role of a Zigbee end device (ZED). Such an end device requires a router node to be designated as its “parent”.

The above however does not address the problem that in existing Zigbee networks that make use of end devices, the route to an end device must be discovered via Ad hoc On-Demand Distance Vector (AODV) route request. This process is time consuming (it adds to the network latency) and it increases the network load due to the large amount of route requests and route replies. Also, the route discovery tables of the nodes in the Zigbee network (i.e. the tables temporarily storing the results of the ongoing route discovery, to keep track of retransmissions of the route requests frame and the changing cost, over the period of 10s) are a limited resource (the Zigbee r22 PICS only requires a minimum of 4 route discovery tables).

The above led to the insight that, sending multiple AODV routes at the same time should be avoided when possible.

The Zigbee specification defines the Parent_annce(_rsp) message, which lists the ZED children of a router by their IEEE address, but it is only used to purge the neighbor/child tables of a rebooting router of stale ZED addresses.

Zigbee also supports the concept of “many-to-one route requests” (MTORR) where a concentrator (typically the gateway) periodically broadcasts an MTORR. When a node receives this MTORR it stores an entry into its routing table indicating that the other node is a concentrator node, this establishes the route from that node to the concentrator.

The present invention aims to ameliorate at least one of the following problems; i.e. to reduce the network load due to route request messages and to reduce the network latency when sending a message to an end device. The latter further improving the user experience.

In order to address the above problem, the present invention aims to enhance a Zigbee router node, by including the addresses of its ZED children in its many-to-one route requests and/or in the regular (AODV) route replies. This provides a node that receives this route message (MTORR or AODV route reply) with the route to the end devices that are included in this message.

In accordance with a first aspect of the invention a wireless Zigbee router node for use in a Zigbee wireless mesh network is provided, the Zigbee router node comprising a radio transceiver arranged to communicate using the Zigbee wireless network protocol, wherein the router node is arranged to include the addresses of its ZED children in its many-to-one route requests and optionally, the Zigbee router node is further arranged to includes the addresses of its ZED children in its (AODV) route replies.

In accordance with a second aspect of the invention a wireless Zigbee router node for use in a Zigbee wireless mesh network is provided, the Zigbee router node comprising a radio transceiver arranged to communicate using the Zigbee wireless network protocol, wherein the router node is arranged to include the addresses of its ZED children in its (AODV) route replies and optionally, the router node is further arranged to include the addresses of its ZED children in its many-to-one route requests.

Preferably the Zigbee router node is a router in a lighting network, and comprised in one of a presence sensor, a light sensor, a lighting switch, a retrofit lamp, a luminaire, and/or a wireless network controller. Lighting networks tend to be dense networks compared to pure RF communication networks, dense referring to the average number of nodes within radio range of other nodes. In part this is a result of requirements from the lighting application, the lighting application, on account of the line of sign character, requires the lighting nodes to be placed in closer proximity to one another than strictly required for RF communication. This becomes even more relevant in office environments where uniform lighting is required and where (daylight and/or presence) sensors and/or switches are deployed within or adjacent to the illuminated area. Thus, the number of nodes in a lighting network tends to be higher than strictly required for radio communication purposes, rendering the present invention particularly advantageous. In accordance with a third aspect of the invention a method is provided for execution by a Zigbee router node for use in a Zigbee wireless mesh network, wherein the router node is arranged to include the addresses of its ZED children in its many-to-one route requests and optionally, the Zigbee router node is further arranged to includes the addresses of its ZED children in its (AODV) route replies.

In accordance with a fourth aspect of the invention a method is provided for execution by a Zigbee router node for use in a Zigbee wireless mesh network, wherein the router node is arranged to include the addresses of its ZED children in its (AODV) route replies and optionally, the router node is further arranged to include the addresses of its ZED children in its many-to-one route requests.

In accordance with a fifth aspect of the invention a Zigbee wireless network is provided using one or more wireless Zigbee routers according to the first and/or second aspect. The system further comprising assigning ZED status to one of more Zigbee wireless network nodes that have router functionality, but that as a result of the dense network structure would “clutter” the routing tables.

A system according to the fifth aspect is preferably configured by assigning ZED status to a number of Zigbee wireless nodes having router functionality; and having a select number of Zigbee wireless routers in the Zigbee wireless network to warrant proper connectivity and redundancy to maintain requirements such as a minimum network connectivity to improve fault-tolerance (e.g. at least two paths (or another pre-determined number of paths) to every node). By having Zigbee routers that may adaptively be configured to deploy either Zigbee router functionality or ZED functionality, network management can be simplified. Effectively these Zigbee router nodes are dual-role nodes. They can operate in a first mode wherein the Zigbee router deploys Zigbee router functionality or instead in a second mode wherein it deploys ZED functionality. By using these Zigbee routers it becomes possible to create a wireless network using a single type of nodes, but at the same time it allows subsequent configuration after installation, for example during commissioning, or during operation through the assignment of the respective roles.

In this manner the number of Router devices, or alternatively worded, the number of network devices that deploy Router device functionality, can be adapted when so required. It becomes possible to limit the number of routers operating in the first mode in dense sections of the network to further alleviate the overhead of route discovery. Moreover, when it turns out that as a result of such configuration routing becomes difficult, it is possible to switch Zigbee routers from the second (ZED) mode operation back to first (router) mode operation, so as to improve routing efficiency where needed.

To facilitate configuration, configuration messages may be sent over the Zigbee wireless mesh network to the respective Zigbee router, such messages might be transmitted during commissioning using a commissioning tool, or during operation from a network controller.

It should be noted that the above, in conjunction with providing information on ZED devices within the MTORR and/or AODV route replies, further improves the route discovery and thus allows for improved Zigbee wireless network management.

The methods according to the invention can also be applied in standalone connected network without any gateway.

The methods can further be applied in any network where ZED nodes are present, since it will reduce the number of route discoveries.

The invention may further be embodied in a computer program comprising code means which, when the program is executed by a node comprising processing means, cause the processing means to carry out any one of the methods of the present invention.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 depicts an example illustrating the concept of the present invention;

FIG. 2 depicts a block diagram of a Zigbee wireless router;

FIG. 3A depicts a flow-chart of a first variant of a method of transmission;

FIG. 3B depicts a flow-chart of a second variant of a method of transmission and

FIG. 4 depicts a flow-chart of a method of configuring router nodes.

### DETAILED DESCRIPTION OF EMBODIMENTS

In accordance with the invention, Zigbee router/coordinator includes the addresses of its ZED children in its many-to-one route requests and/or in the regular (AODV) route replies. This provides a node that receives this route message (MTORR or AODV route reply) with the route to the end devices that are included in this message.

Before a router/coordinator sends out a many-to-one route request, an AODV route request (in case of nwkSymLink=true) or AODV route reply (in case of nwkSymLink=false), it first reads out its child table or that portion of its neighbour table, which includes the NWK addresses of the end devices that are bound to it. This information is used to add a new parameter: list of ZED children in the payload of the many-to-one route request and the AODV route reply, by including the NWK address of each end device.

Many-to-one route request (extension to the Zigbee-standardized Route Request Command is the “Variable” field in the below table):

| Octets: 1 | 1 | 2 | 1 | 0/8 | Variable |
|---|---|---|---|---|---|
| Command | Route | Destination | Path | Destination | List of NWK |
| options | request | address | cost | IEEE | addresses of |
| | identifier | | | address | end devices |

NWK command payload

AODV route reply (extension to the Zigbee-standardized Route Reply Command is the “Variable” field in the below table):

| Octets: 1 | 1 | 2 | 2 | 1 | 0/8 | 0/8 | Variable |
|---|---|---|---|---|---|---|---|
| Command | Route | Originator | Responder | Path | Originator | Responder | List of |
| options | request | address | address | cost | IEEE | IEEE | NWK |
| | identifier | | | | address | address | addresses |
| | | | | | | | of end |
| | | | | | | | devices |

NWK command payload

In case an MTORR is received that contains a list of NWK addresses, each Zigbee router node will add not only the route for the concentrator to its routing table, but at the same time creates entries for all the ZED children of that concentrator. Same applies to received AODV route requests in case of nwkSymLink=true, because then routes are assumed to be comprised of symmetric links and the forward and backward route are created in a single route discovery.

The above refers to the case where the routing table does not have an entry for a certain destination. In case an entry already exists, the entry may be replaced/updated with the newly obtained information.

As a result, parent routers should be able to process MTORR errors on behalf of their ZED children.

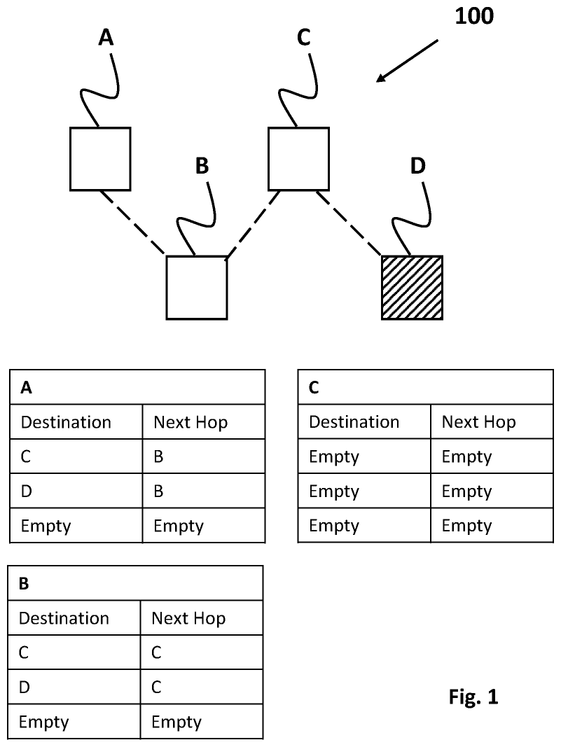

See the FIG. 1 for further explanation. The lines in this figure symbolize the existence of links between nodes, i.e. node B has a direct link to node A and C. Node A, B, C are router nodes, node D is a ZED (and has no routing table).

The figure explains the example where node C sends its MTORR, including its ZED child D. Nodes B and A receive the MTORR and add the routes to nodes C and D to their routing table.

In case an AODV route reply is received that contains a list of NWK addresses, the originator will add next to the route for the destination, also the routes for the children of the destination to its routing table.

The new parameter can be appended at the end of the command as an additional parameter; its presence could be indicated using one of the reserved fields of the Command Options field of the RREQ command frame.

### Route Request Command Options Field

| Bit: 0 to 2 | Bit 3 and 4 | Bit 5 | Bit 6 | 7 |
|---|---|---|---|---|
| Reserved | Many-to-one | Destination | Multicast | Reserved |
| | | IEEE address | | |

Alternatively, it can also be appended as a self-describing Type Length Value (TLV) field. Zigbee Revision 23 will allow the addition of TLVs to many Zigbee commands. Preferably, the many-to-one route request and/or AODV route reply include the list of NWK addresses by means of such a TLV.

In extension, the parent can trigger the route discovery (MTORR or AODV in case of nwkSymLink=true), e.g. upon a local change at the parent, e.g. new ZED child joining or re-joining at the parent, upon resolving an address conflict for the child node—or upon a remote change, e.g. when the parent detects that a new node has joined (e.g. on reception of Device-annce).

In a simplest embodiment, the list of ZED children can be included in every affected routing command sent by the router. In another embodiment, to limit the length of the respective routing frame, the ZED children list can only be included in selected affected routing messages, e.g. every Nth message, or depending on the polling frequency of the child (in every routing message if the child is fast polling or in a frequency matching the child's polling frequency) or the state the network is in: in the joining phase, when many devices are joining, it could be added in every affected routing message, and as the joining frequency gets lower—or the commissioning mode gets disabled on the network—the list be included less often.

As a further optimisation, the relation between the child and the parent could be preserved in the receiving remote nodes. Thus, when a change of the route to the parent or any of its children would be detected (e.g. a new route would be established or a route error reported), the routes to the parent and/or (other) children could be updated automatically, without the parent including the (complete) list of ZED children; the relationship could be preserved e.g. until the ZED child rejoins, the parent leaves the network or until another indication of parent change is received.

In case of RREP, the responding parent node could always include the list of ZED children—or only if triggered by the RREQ, e.g. by inclusion of another “ZED query” TLV— or by inclusion of the ZED list by the RREQ originator.

Furthermore, in very dense systems, where a router may serve multiple ZED children, the children list may be too long for a single routing command. Then it may need to be delivered in chunks, split over several messages. Alternatively, it only includes a selected subset of its ZED children, such that the children list fits a single routing command.

In some situations, e.g. when the parent detects that a new router node has joined (e.g. on reception of Device_annce with device type flag of the Capability information field set to FFD), it may be beneficial to not only include the short address of the ZED nodes of the router, but also their IEEE addresses; this will not only save the independent route discoveries for the children, but also the multiple unicast IEEE_addr_req.

Furthermore, the parent may only include the ZED children on a need to know basis, e.g. if it is aware of any bindings on or to a ZED child, or if RREQs have been generated on behalf of or received for the child, within a defined time period, or since its joining.

Equally, nodes receiving an MTORR with a child list could be selective as to routes to which children to store locally; e.g. using information about bindings and RREQs. They may need to overwrite a previously established route to the ZED child with the information received in the parent's routing frame. This may also lead to changing the routing table entry type, e.g. from AODV route (which needs to be repaired via a broadcast RREQ) to an MTORR route (which can be repaired by sending unicast route error message to the route destination, using the fact that any router neighbour should have a working route to a concentrator).

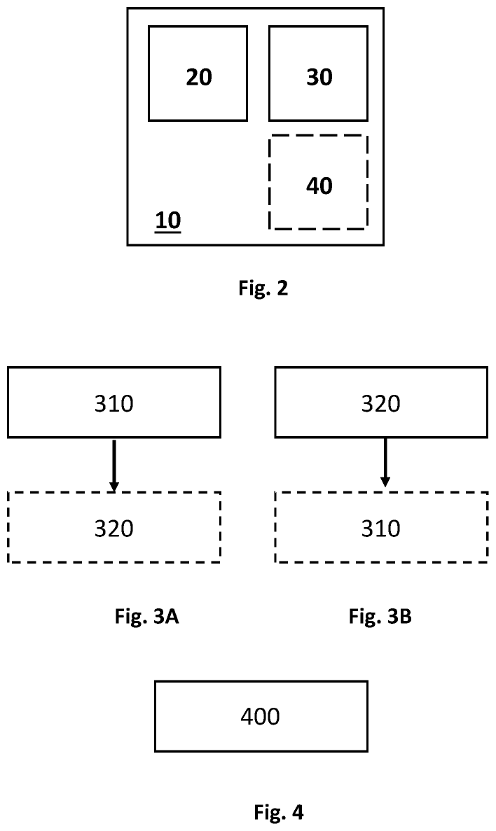

FIG. 2 provides block diagram of a Zigbee wireless router 10, comprising a controller 20 and a radio transceiver 30 arranged to communicate using the Zigbee wireless network protocol as used by various embodiments of the present invention. Optionally, the Zigbee wireless router comprises a routing table 40 for storing route information. Alternatively, the route information may be stored as a data structure in another storage means, such as a memory of the controller, known in the art.

FIG. 3A provides a flow-chart of a first variant of a method for execution by a Zigbee router node for use in a Zigbee wireless mesh network, wherein the router node is arranged to include 310 the addresses of its ZED children in its many-to-one route requests and optionally, the Zigbee router node is further arranged to include 320 the addresses of its ZED children in its (AODV) route replies.

FIG. 3B provides a flow-chart of a second variant of a method for execution by a Zigbee router node for use in a Zigbee wireless mesh network, wherein the router node is arranged to include 320 the addresses of its ZED children in its (AODV) route replies and optionally, the router node is further arranged to include 310 the addresses of its ZED children in its many-to-one route requests.

FIG. 4 provides a flow-chart of a further method, for configuring a Zigbee wireless mesh network, which method involves configuring (400) by assigning ZED status to a number of Zigbee wireless nodes having router functionality; and having a select number of Zigbee wireless routers in the Zigbee wireless network to warrant proper connectivity and redundancy to maintain requirements such as a minimum network connectivity to improve fault-tolerance (e.g. at least two paths (or another pre-determined number of paths) to every node).

The methods according to the invention may be implemented on a computer as a computer implemented method, or in dedicated hardware, or in a combination of both.

Executable code for a method according to the invention may be stored on computer/machine readable storage means. Examples of computer/machine readable storage means include non-volatile memory devices, optical storage medium/devices, solid-state media, integrated circuits, servers, etc. Preferably, the computer program product comprises non-transitory program code means stored on a computer readable medium for performing a method according to the invention when said program product is executed on a computer or a processing means comprised in a node or a network or a commissioning device as disclosed in the above-described embodiments.

Methods, systems and computer-readable media (transitory and non-transitory) may also be provided to implement selected aspects of the above-described embodiments.

The term “controller” is used herein generally to describe various apparatus relating to, among other functions, the operation of one or more network devices or coordinators. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, compact disks, optical disks, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “network” as used herein refers to any interconnection of two or more devices (including controllers or processors) that facilitates the transport of information (e.g. for device control, data storage, data exchange, etc.) between any two or more devices and/or among multiple devices coupled to the network.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

1. A Zigbee router for use in a Zigbee wireless mesh network the Zigbee router comprising:
a controller and
a radio transceiver arranged to communicate using the Zigbee wireless network protocol,
wherein the controller is arranged to include addresses of Zigbee End Device, ZED, child nodes of the Zigbee router, in many-to-one route requests (MTORRs) that the Zigbee router transmits, and
the Zigbee router is arranged to upon receipt of an MTORR from a concentrator that comprises a list of ZED addresses in the MTORR, add or update an entry in the route table for the concentrator and add or replace entries for all of the ZED children of that concentrator to the routing table.

2. The Zigbee router of claim 1, wherein:
the controller is arranged to include the addresses of the ZED child nodes of the Zigbee router in AODV route replies that the Zigbee router transmits.

3. A Zigbee router for use in a Zigbee wireless mesh network, the Zigbee router comprising:
a controller and
a radio transceiver arranged to communicate using the Zigbee wireless network protocol,
wherein the controller is arranged to include addresses of ZED child nodes of the Zigbee router in AODV route replies that the Zigbee router transmits and the Zigbee router is arranged to upon receipt of an AODV route reply that comprises a list of ZED addresses from a further Zigbee router and nwkSymLink=true, add or update a route entry for the further router and route entries for all of the ZED children of the further router to the routing table.

4. The Zigbee router of claim 3, wherein:
the controller is arranged to include the addresses of the ZED child nodes of the Zigbee router, in many-to-one route requests (MTORRs) that the Zigbee router transmits.

5. (canceled)

6. The Zigbee router according to claim 1, wherein the Zigbee router is a router in a lighting network, and is comprised in one of a presence sensor, a light sensor, a lighting switch, a retrofit lamp, a luminaire, or a wireless network controller.

7. The Zigbee router according to claim 1, wherein the radio transceiver is arranged to receive a configuration package via the wireless mesh network, wherein the configuration package provides instructions for the Zigbee router, and wherein the configuration package is passed on to the controller and wherein the controller is configured to:
switch the Zigbee router, when operating in a first mode wherein it deploys Zigbee router functionality, from the first mode to a second mode, wherein the Zigbee router deploys ZED node functionality when the configuration package so indicates.

8. The Zigbee router according to claim 6, wherein the radio transceiver is arranged to receive a further configuration package via the wireless network wherein the configuration package provides instructions for the Zigbee router, and wherein the controller is configured to switch the Zigbee router when operating in the second mode from the second mode to the first mode when the configuration package so indicates.

9. A method for execution by a Zigbee router for use in a Zigbee wireless mesh network,
the method comprising:
including, by a Zigbee router node, addresses of Zigbee End Device (ZED) child nodes of the Zigbee router, in many-to-one route requests (MTORRs) that the Zigbee router transmits and
upon receipt of an MTORR from a concentrator that comprises a list of ZED addresses in the MTORR, adding or updating, by the Zigbee router node, an entry in the route table for the concentrator and add or replace entries for all of the ZED children of that concentrator to the routing table.

10. The method of claim 9, comprising:
including, by the Zigbee route node, the addresses of ZED child nodes of the Zigbee router in AODV route replies that the Zigbee router transmits.

11. A method for execution by a Zigbee router for use in a Zigbee wireless mesh network,
the method comprising:
including, by a Zigbee router, the addresses of ZED child nodes of the Zigbee router in AODV route replies that the Zigbee router transmits and
upon receipt of an AODV route reply that comprises a list of ZED addresses from a further Zigbee router and nwkSymLink=true, adding or updating, by the Zigbee router node, a route entry for the further router and route entries for all of the ZED children of the further router to the routing table.

12. The method of claim 11, comprising:
including, by the Zigbee router node, addresses of Zigbee End Device, ZED, child nodes of the Zigbee router, in many-to-one route requests that the Zigbee router transmits.

13. A Zigbee wireless network comprising a plurality of Zigbee wireless routers according to claim 1.

14. The network of claim 13, wherein there are a plurality of Zigbee router nodes according to claim 6.

15. A method of configuring a network according to claim 13, the method comprising:
configuring by assigning the second mode to a number of Zigbee routers operating in the first mode by means of a configuration message.
